(19) United States
(12) Patent Application Publication
(10) Pub. No.: US 2009/0139168 A1
(43) Pub. Date: Jun. 4, 2009

(54) INTERIOR TRIM SYSTEM FOR USE OVER EXISTING MOLDING

(76) Inventors: Lenny Grissom, Saint Petersburg, FL (US); Richard Eckaus, Tampa, FL (US)

Correspondence Address: Lauson & Tarver LLP, 880 Apollo Street, SUITE 301, El Segundo, CA, 90245, US

(21) Appl. No.: 11/947,657

(22) Filed: Nov. 29, 2007

(51) Int. Cl. E04D 1/36; B28B 7/00; E04B 2/84; E04C 1/39

(52) U.S. Cl. 52/288.1; 249/13; 52/287.1; 52/366; 52/465

(57) ABSTRACT

An interior trim system comprising two-piece baseboards, baseboard end caps, window and door casings, crown moldings and window sill caps, the baseboards and crown molding formed with pre-mitered inside and outside corner pieces. The baseboards, end caps, casings and window sill caps can be installed over existing baseboards, casings and window sills without removing the original trim, and are glued into place with instant-hold glue. A template for accurately cutting the window sill cap is included in the system along with a miter guide provided for accurately cutting lengths of baseboards, casings, and crown molding.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Molding and trim for interior rooms are known in the art. However, interior trim is typically installed at the completion of a construction process and comprises various lengths of milled wood, nailed into the walls and ceiling of a room that must be removed prior to replacement or repair. This time consuming process is typically performed by professional carpenters. Therefore, there is a need for an interior trim system that can be installed over existing trim pieces by a lay person without removing existing trim.

U.S. Pat. No. 6,189,276 to Pinto et al discloses an overlay molding strip that can be used to cover an existing molding. Although the purpose of this strip is similar to the present invention, it differs in both structure and function. The present invention is directed to a two piece interlocking molding to cover an existing molding, whereas Pinto discloses a single piece with a notch cut out of the back. Additionally, Pinto is designed to be installed in the same manner as any ordinary molding, i.e.; by nailing it into position, whereas the present invention is designed to be glued into place and comprises a waterproof, mold and mildew impervious, and termite proof molding. Furthermore, the present invention comprises end caps that allow the basebord to adjoin an existing door casing without leaving an overhang at the front edge of the board where it adjoins the casing; an improvement not contemplated by Pinto.

It is therefore an object of the present invention to provide an interior trim system comprising baseboards, casings, crown moldings and window sill caps, comprised of an extruded plastic material that can be easily cut, including pre-mitered corner pieces, that can be installed using instant-hold glue, while obviating the need for painting.

A further object of the present invention is to provide an interior trim system in a variety of sizes and colors, using a waterproof material that will not mold or mildew, is impervious to termites, wherein the system can be installed directly over existing trim.

### SUMMARY

An interior room trim system consisting of two-piece baseboards, door and window casings, crown molding and window sill cap pieces, including a template and miter guide for accurately cutting the pieces; to be installed by persons with little or no carpentry experience, including homeowners. The baseboards are installed over existing baseboards, the door and window casings are installed over existing casings, the crown molding is installed over a series of crown molding support members, and the window sill cap is installed over an existing window sill. The members of the system are affixed in place with a gluing means, including a fast acting and instant grab glue that allows for slight adjusting before setting. In a preferred embodiment of the invention, the members are comprised of plastic, including a polymer, and are finished so that no painting is necessary.

The baseboard comprises a two piece system, a bottom member and top member, that installs over an existing baseboard. The bottom member and top member fit in a nested configuration. The bottom of the top member comprises a notch to receive and support the bottom member and creates a reveal to the baseboard. End caps comprising a bottom member and a top member corresponding to the bottom and top members of the baseboard are used with existing door casings to cleanly terminate the baseboard against an existing casing. In the event the door and window casing of the instant invention is used in connection with the baseboards, no end cap is necessary.

In order to install the baseboard of the present invention, in an embodiment where end caps are used, a small section of existing baseboard adjacent to an existing door casing is notched out, and the bottom and top members of an end cap are affixed in position at the terminus of the existing baseboard. Thereafter, the remaining required lengths of baseboard are measured, and two boards, one comprising the bottom member, and one comprising the top member are cut to the appropriate length, using the miter guide if necessary. The baseboards are also manufactured with miters to accommodate an inside corner and outside corner, as well as adjoining to baseboard members along a straight run.

The door and window casing is a notched casing that fits over an existing door or window casing. The casing comprises an enlarged casing, including a four inch door casing of the same profile as the baseboard. The door and window casings are used to cover a pre-existing casing, and obviate the need for baseboard end caps.

The crown molding of the present invention comprises a series of tubular triangular support members affixed to a wall and ceiling, and a series of crown molding members affixed to the exposed face of the support members. The crown molding members have mitered ends similar to the base boards. The crown molding is manufactured, like the baseboards, with miters to accommodate inside and outside corners. The inside and outside corner crown molding members have pre-cut compound miters that adjoin at a corner, and are mitered to adjoin straight run crown molding members.

The window sill cap is installed over an existing window sill. Using a template included as a part of the system, including a template built into the packaging, the window sill cap can be trimmed along trim lines at the sides and rear of the sill cap to fit a variety of standard size window sills. The system also comprises a miter guide to ensure accurate angles when cutting the various pieces of trim. The miter guide slides over a piece of trim such as a baseboard and is used as a guide for cutting to make accurate forty five degree bevels. FIGURES

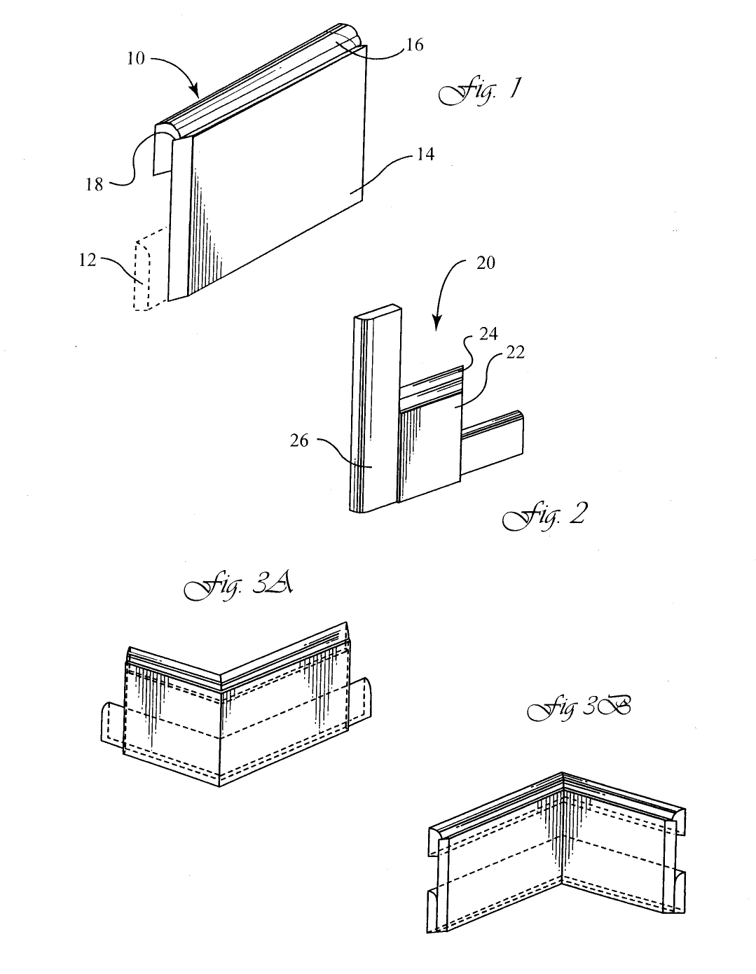

FIG. 1 is a perspective view of the baseboard of the present invention as installed over an existing baseboard.

FIG. 2 is a perspective view of the baseboard end cap adjoining a pre-existing door casing.

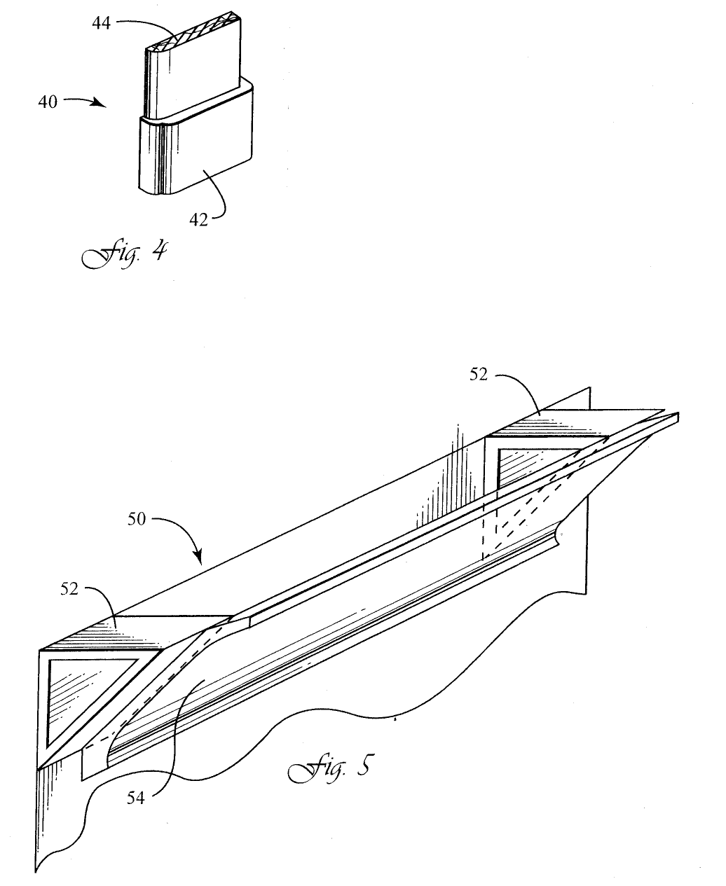

FIGS. 3A and 3B are a perspective views of the baseboard corner pieces installed at inside and outside corners.

FIG. 4 is a perspective view of the window and door casing of the present invention, installed over an existing casing.

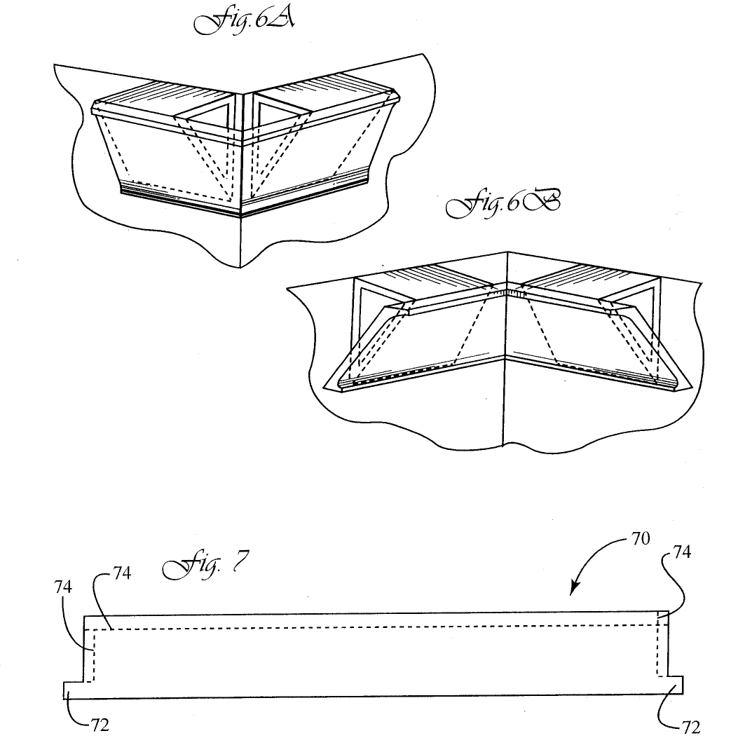

FIG. 5 is a perspective view of the crown molding and crown molding support members of the present invention.

FIGS. 6A and 6B are perspective views of the crown molding corner pieces installed at inside and outside corners.

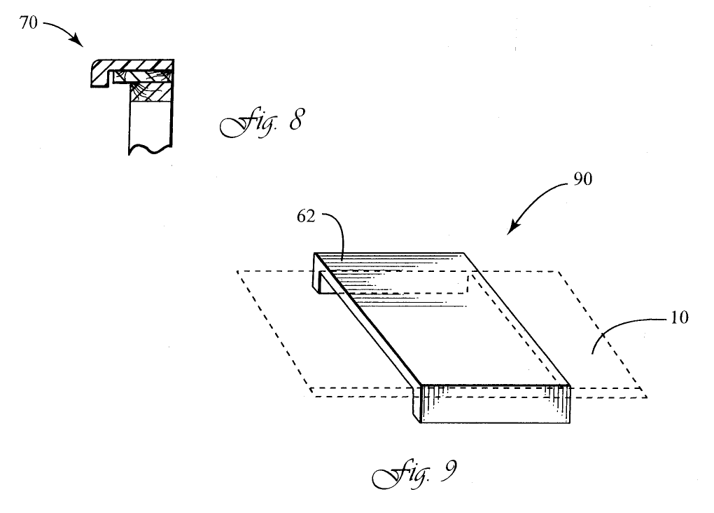

FIG. 7 is a top view of the window sill cap of the present invention.

FIG. 8 is a cut-away side view of the window sill cap of the present invention.

FIG. 9 is a perspective view of the miter guide of the present invention.

### DESCRIPTION

The present invention comprises an interior room trim system comprising of baseboards, door and window casings, crown molding and window sill cap pieces, including a template and miter guide for accurately cutting the pieces; to be installed by persons with little or no carpentry experience, including homeowners. The baseboards are installed over existing baseboards, the door and window casings are installed over existing casings, the crown molding is installed over a series of crown molding support members, and the window sill cap is installed over an existing window sill. The members of the system are affixed in place with a gluing means, including a fast acting and instant grab glue that allows for slight adjusting before setting. In a preferred embodiment of the invention, the members are comprised of plastic, including a polymer, and are finished so that no painting is necessary.

Referring to FIG. 1, the baseboard 10 of the present invention comprises a two piece system that installs over an existing baseboard 12. The baseboard comprises a bottom member 14, and a top member 16 that fits over the bottom member 14 in a nested configuration. In one preferred embodiment, the bottom of the top member 16 comprises a notch 18 to receive the bottom member 14 in a manner that creates a ⅛ inch reveal to the baseboard 10.

Referring to FIG. 2, an end cap is shown that may be used in connection with the baseboard. The end cap 20 is “L” shaped in plan view, and comprises a bottom member 22 and a top member 24 corresponding to the bottom and top members of the baseboard. When the baseboards of the system are used with an existing door casing 26, the end cap serves to cleanly terminate the baseboard. In the event the door and window casing of the instant invention is used in connection with the baseboards, no end cap is necessary.

In order to install the baseboard of the present invention, in an embodiment where end caps are used, a small section of existing baseboard adjacent to an existing door casing is notched out, and the bottom and top members of an end cap are affixed in position at the new terminus of the existing baseboard. Thereafter, the remaining required length of baseboard is measured, and two boards, one comprising the bottom member, and one comprising the top member are cut to the appropriate length, using the miter guide if necessary.

The end caps, packaged separately in one embodiment, are mitered to align with the baseboards. In various preferred embodiments, the baseboards are manufactured in six inch and eight inch sizes, and may be manufactured with multiple profile styles.

Referring to FIGS. 3A and 3B, the baseboards are also manufactured with miters to accommodate an inside corner, and outside corner, in addition to the straight run baseboard members.

Referring to FIG. 4, the door and window casing 40 is a notched casing that fits over an existing door or window casing. The casing comprises an enlarged casing 42, including a four inch door casing of the same profile as the baseboard. The door and window casing 42 is used to cover a pre-existing casing 44, and obviates the need for end caps. The casing can be cut at a forty five degree angle to extend around doors and windows.

Referring to FIG. 5, the crown molding 50 of the present invention comprises a series of tubular support members 52, triangular in cross-section, which are affixed to a wall and ceiling, so that the side of the member comprising the hypotenuse of the triangle faces the interior of a room. The crown molding 50 further comprises a series of crown molding members 54 comprising a proximal end and a distal end, affixed to the exposed face of the support members 52 to achieve a uniform angle relative to the wall and ceiling of a room. The crown molding members 54 have mitered ends similar to the base boards.

In order to install the crown molding, the support members 52 are adhered to the walls and ceiling of a room at 16 inch intervals. This distance corresponds to the length of the crown molding members, so that each support member is able to support the proximal end of one crown molding member, and the distal end of an adjacent crown molding member.

Referring to FIGS. 6A and 6B, some members of crown molding, like the base boards, are manufactured with miters to accommodate inside and outside corners. The inside and outside corner crown molding members have pre-cut compound miters that adjoin at a corner, and are mitered at the opposite end to adjoin the straight length crown molding members. In a further preferred embodiment, the support members comprise three inch lengths affixed at sixteen inch intervals and spaced sixteen inches on center.

Referring to FIGS. 7 and 8, a window sill cap 70 can be installed over an existing window sill. The sill cap 70 has dog ears 72 that cover the sides of the existing window sill. Using a template included as a part of the system, the window sill cap can be trimmed along trim lines 74 at the sides and rear of the sill cap 70 to fit a variety of standard size window sills.

Referring to FIG. 9, the system also comprises a miter guide to ensure accurate angles when cutting the various pieces of trim. The miter guide 90 comprises a U-channel shaped member 62 that slides over a piece of trim such as a baseboard 10, or other pieces of trim (not shown). The miter can be placed over a piece of base or crown molding and used as a cutting guide to make an accurate forty five degree bevel. In further preferred embodiments, the miter guide comes in sizes of four, six and eight inches, for use with trim pieces of corresponding size.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved finish carpentry system and method of installation comprising;
a. at least one member of the group consisting of base boards, door casings, window casings, ceiling moldings, and window sill caps; and
b. a means for guiding a cutting means, including a miter guide for cutting the members; wherein,
c. installation of the ceiling molding members is guided by a backing member, installation of base boards can be accomplished by assembling two members over an existing molding, and installation of the casing can be accomplished by covering an existing casing so that the existing casing enters a notch at the rear of the new casing.

2. The system of claim 1, wherein the baseboards are comprised of upper and lower intersecting members.

3. The system of claim 2, wherein the intersecting pieces comprise a first member disposed in front of an existing baseboard, and a second member disposed over an existing baseboard, wherein the pieces intersect in a manner that covers the existing baseboard.

4. The system of claim 3, wherein the first and second members interlock.

5. The system of claim 2, wherein the base boards are mitered to abut a door casing by employing a mitered edge.

6. The system of claim 2, wherein the base boards are glued into position.

7. The system of claim 1, wherein a support member, triangular in cross section, is installed between a wall, ceiling, and the crown molding to hold the crown molding in position.

8. The system of claim 7, wherein the crown molding is glued to the support member.

9. The system of claim 1, wherein the window sill cap can be fitted over an existing window sill.

10. The system of claim 9, wherein the window sill cap comprises standard window sizes.

11. The system of claim 9, wherein the system comprises a template for accurately cutting the window sill cap.

12. The system of claim 11, wherein the template is incorporated into the packaging for the system.

13. The system of claim 12, wherein the template can be trimmed with scissors.

14. The system of claim 1, wherein the miter guide is used in connection with a cutting means when cutting the baseboard members and crown molding members to length.

15. The system of claim 1, wherein the assembled baseboard moldings are between six and eight inches in height.

16. The system of claim 1, wherein members comprise of an extruded acrylic polymer.

17. The system of claim 1, wherein members are white in color.

18. The system of claim 1, wherein the members have a gloss finish.

19. The system of claim 6, wherein the members are installed with instant grab glue.

20. The system of claim 1, wherein members are packaged in a manner permitting a single package to finish the walls, doors, windows and ceiling of an entire room.

21. The system of claim 1, wherein end caps are employed to cap the baseboards at an existing door casing

22. The system of claim 21, wherein the end caps comprise an upper and lower piece, corresponding in cross section to the upper and lower members of the baseboard.

23. The system of claim 1, wherein multiple profiles and heights of baseboard, casing and molding are employed.

24. A method of installing extruded acrylic polymer prefabricated finish molding products, comprising the steps of;
a. measuring a specified length to be fitted with a two-piece baseboard;
b. cutting both pieces of the baseboard or casing to the specified length, using a miter guide if necessary;
c. Installing the pieces of the baseboard or casing by fitting them over an existing baseboard, locking them together, and gluing them in place;
d. measuring a specified length to be fitted with crown molding;
e. installing support members, triangular in cross section, to the specified length and affixing them at the intersection of a wall and ceiling;
f. cutting a piece of crown molding, using a miter guide if necessary.
g. installing the crown molding on the support member, by gluing it in place;
h. Cutting a window sill cap, using a template as a guide, and installing it over an existing window sill by gluing it in place; and
i. installing door and window casings over existing door and window casings in a manner that permits the existing casings to be disposed in a notch in the rear of the door and window casing.
